(19) United States
(12) Patent Application Publication
(10) Pub. No.: US 2025/0156110 A1
(43) Pub. Date: May 15, 2025

(54) TRANSMITTING METHOD, RECEIVING METHOD, TRANSMITTING APPARATUS, RECEIVING APPARATUS, AND RECORDING MEDIUM

(71) Applicant: NEC Corporation, Tokyo (JP)

(72) Inventor: Yohei HASEGAWA, Tokyo (JP)

(73) Assignee: NEC Corporation, Tokyo (JP)

(21) Appl. No.: 18/937,254

(22) Filed: Nov. 5, 2024

(30) Foreign Application Priority Data
Nov. 15, 2023 (JP) 2023-194689

(51) Int. Cl. G06F 3/06

(52) U.S. Cl. CPC G06F 3/0656; G06F 3/0604; G06F 3/0673

(57) ABSTRACT

Realized is a technique of suppressing an increase in processing cost in a case of introducing a new encoding scheme into an existing communication scheme. A transmitting apparatus includes: a memory which includes a first area in which transmission data in an application layer of a communication model is stored and a second area in which transmission data in a lower layer that is below the application layer is stored; a reading section which, in the application layer, reads out, from the first area, a plurality of data segments into which the transmission data in the application layer has been divided; and an encoding and transmitting section which, in the application layer, writes, in the second area, an encoded data segment as the transmission data in the lower layer, while generating the encoded data segment with use of the plurality of data segments.

This Nonprovisional application claims priority under 35 U.S.C. § 119 on Patent Application No. 2023-194689 filed in Japan on Nov. 15, 2023, the entire contents of which are hereby incorporated by reference.

### TECHNICAL FIELD

The present disclosure relates to a transmitting method, a receiving method, a transmitting apparatus, a receiving apparatus, and a recording medium.

### BACKGROUND ART

Non-Patent Literature 1 discloses that data copy processing time accounts for a large part of processing time for a communication protocol. In order to reduce a load in such communication protocol processing, it is known to process a division of transmission data, a checksum computation, and the like by hardware such as a network interface. For example, Patent Literature 1 discloses a communication apparatus having an offload processing section (hardware). The offload processing section executes a dividing process of dividing transmission data to be transmitted into pieces of segment data and a header generating process of generating a header and adding the header to each of the divided pieces of segment data, in place of an operating system (OS) kernel.

### CITATION LIST

### Non-Patent Literature

### [Non-Patent Literature 1]

D. D. Clark, V. Jacobson, J. Romkey and H. Salwen, “An analysis of TCP processing overhead,” IEEE Communications Magazine, vol. 27, no. 6, pp. 23-29, June 1989, doi: 10.1109/35.29545.

### Patent Literature

### [Patent Literature 1]

Japanese Patent Application Publication Tokukai No. 2023-031710

### SUMMARY OF INVENTION

### Technical Problem

Here, in a case where a new encoding scheme is introduced into an existing communication scheme in the communication apparatus disclosed in Patent Literature 1, there is a problem that processing cost increases. This is because, in addition to a data copying process in the existing communication scheme, data reading and writing (data copying process) with respect to a memory occurs in a new encoding process, and, therefore, a twofold data copying process occurs and processing performance is approximately halved.

The present disclosure has been made in view of the above problems, and an example object thereof is to provide a technique of suppressing an increase in processing cost in a case of introducing a new encoding scheme into an existing communication scheme.

### Solution to Problem

A transmitting method in accordance with an example aspect of the present disclosure is a transmitting method which is executed by a transmitting apparatus including at least one processor and a memory, the memory including a first area in which transmission data in an application layer of a communication model is stored and a second area in which transmission data in a lower layer that is below the application layer is stored, the transmitting method including: a reading process in which, in the application layer, the at least one processor reads out, from the first area, a plurality of data segments into which the transmission data in the application layer has been divided; and an encoding and transmitting process in which, in the application layer, while generating an encoded data segment with use of the plurality of data segments, the at least one processor writes, in the second area, the encoded data segment as the transmission data in the lower layer.

A receiving method in accordance with example aspect of the present disclosure is a receiving method in which a receiving apparatus including at least one processor and a memory receives the encoded data segment that has been transmitted by the foregoing transmitting method, the memory including a third area in which reception data in the lower layer is stored and a fourth area in which reception data in the application layer is stored, the receiving method including: a reading process in which, in the application layer, the at least one processor reads out, from the third area, the encoded data segment which is the reception data in the lower layer; and a receiving and decoding process in which, in the application layer, while obtaining a data segment which has been decoded with use of the encoded data segment, the at least one processor writes, in the fourth area, the data segment which has been decoded, as the reception data in the application layer.

A transmitting apparatus in accordance with an example aspect of the present disclosure is a transmitting apparatus including at least one processor and a memory, the memory including a first area in which transmission data in an application layer of a communication model is stored and a second area in which transmission data in a lower layer that is below the application layer is stored, the at least one processor executing: a reading process of, in the application layer, reading out, from the first area, a plurality of data segments into which the transmission data in the application layer has been divided; and an encoding and transmitting process of, in the application layer, while generating an encoded data segment with use of the plurality of data segments, writing, in the second area, the encoded data segment as the transmission data in the lower layer.

A receiving apparatus in accordance with an example aspect of the present disclosure is a receiving apparatus which receives the encoded data segment that has been transmitted by the foregoing transmitting apparatus, the receiving apparatus including at least one processor and a memory, the memory including a third area in which reception data in the lower layer is stored and a fourth area in which reception data in the application layer is stored, the at least one processor executing: a reading process of, in the application layer, reading out, from the third area, the encoded data segment which is the reception data in the lower layer; and a receiving and decoding process of, in the application layer, while obtaining a data segment which has been decoded with use of the encoded data segment, writing, in the fourth area, the data segment which has been decoded, as the reception data in the application layer.

A non-transitory recording medium in accordance with an example aspect of the present disclosure is a non-transitory recording medium in which a transmission program for causing at least one processor to execute the foregoing transmitting method is recorded, the transmission program causing the at least one processor to execute the reading process and the encoding and transmitting process.

A non-transitory recording medium in accordance with an example aspect of the present disclosure is a non-transitory recording medium in which a reception program for causing at least one processor to execute the foregoing receiving method is recorded, the reception program causing the at least one processor to execute the reading process and the receiving and decoding process.

### Advantageous Effects of Invention

An example aspect of the present disclosure brings about an example effect that it is possible to provide a technique of suppressing an increase in processing cost in a case where introducing a new encoding scheme into an existing communication scheme.

### BRIEF DESCRIPTION OF DRAWINGS

FIG. 1 is a block diagram illustrating a configuration of a transmitting apparatus in accordance with the present disclosure.

FIG. 2 is a flowchart illustrating a flow of a transmitting method in accordance with the present disclosure.

FIG. 3 is a drawing schematically illustrating an effect of the transmitting method in accordance with the present disclosure.

FIG. 4 is a block diagram illustrating a configuration of a receiving apparatus in accordance with the present disclosure.

FIG. 5 is a flowchart illustrating a flow of a receiving method in accordance with the present disclosure.

FIG. 6 is a drawing schematically illustrating an effect of the receiving method in accordance with the present disclosure.

FIG. 7 is a block diagram illustrating a configuration of a communication system in accordance with the present disclosure.

FIG. 8 is a flowchart illustrating a flow of a transmitting method in accordance with the present disclosure.

FIG. 9 is a drawing schematically illustrating the transmitting method in accordance with the present disclosure.

FIG. 10 is a drawing schematically illustrating an encoding and transmitting process in accordance with the present disclosure.

FIG. 11 is a flowchart illustrating a flow of a receiving method in accordance with the present disclosure.

FIG. 12 is a drawing schematically illustrating the receiving method in accordance with the present disclosure.

FIG. 13 is a drawing schematically illustrating a receiving and decoding process in accordance with the present disclosure.

FIG. 14 is a block diagram illustrating an example of a configuration of a computer which functions as each apparatus in accordance with the present disclosure.

### EXAMPLE EMBODIMENTS

The following will exemplify embodiments of the present invention. Note, however, that the present invention is not limited to the example embodiments described below, but may be altered in various ways by a skilled person within the scope of the claims. For example, the present invention can also encompass, in its scope, any example embodiment derived by appropriately combining technical means employed in the example embodiments described below. Further, the present invention can also encompass, in its scope, any example embodiment derived by appropriately omitting a part of a technical means employed in each of the example embodiments described below. Further, the effects mentioned in the example embodiments described below are examples of the effects expected in the example embodiments described below, and are not intended to define an extension of the present invention. That is, the present invention can also encompass, in its scope, any example embodiment that does not bring about any of the effects mentioned in the example embodiments described below.

### Features of Example Embodiments

### First Example Embodiment

The following description will discuss a first example embodiment, which is an example of an embodiment of the present invention, in detail, with reference to the drawings. The present example embodiment is a basic form of the example embodiments described later. Note that the scope of application of technical means which are employed in the present example embodiment is not limited to the present example embodiment. That is, the technical means which are employed in the present example embodiment can be employed also in the other example embodiments included in the present disclosure, within a range in which no particular technical problem occurs. Moreover, technical means which are indicated in the drawings referred to for describing the present example embodiment can be employed also in the other example embodiments included in the present disclosure, within a range in which no particular technical problem occurs.

### (Configuration of Transmitting Apparatus)

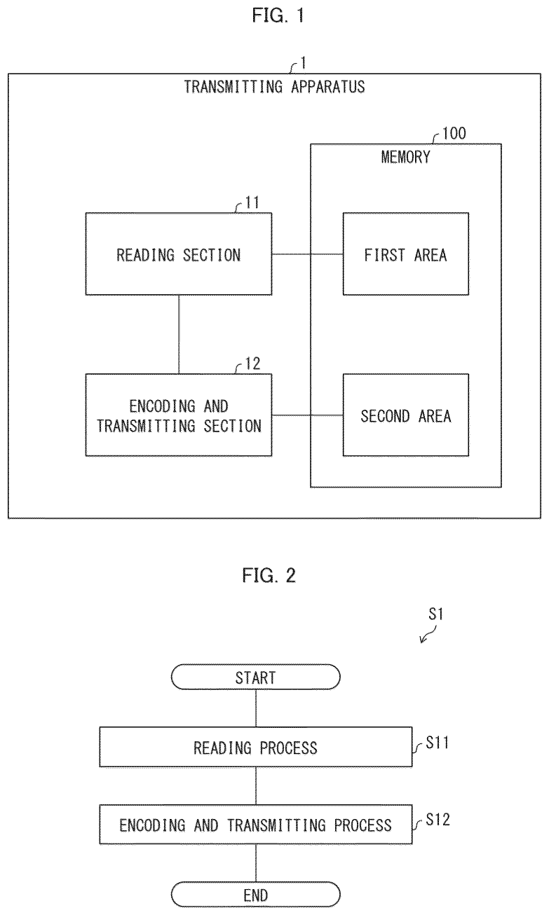

A configuration of a transmitting apparatus 1 is described with reference to FIG. 1. FIG. 1 is a block diagram illustrating the configuration of the transmitting apparatus 1. The transmitting apparatus 1 includes a reading section 11, an encoding and transmitting section 12, and a memory 100, as illustrated in FIG. 1.

The memory 100 includes a first area in which transmission data in an application layer of a communication model is stored and a second area in which transmission data in a lower layer that is below the application layer is stored. In the application layer, the reading section 11 reads out, from the first area, a plurality of data segments into which the transmission data in the application layer has been divided. In the application layer, while generating an encoded data segment with use of the plurality of data segments, the encoding and transmitting section 12 writes, in the second area, the encoded data segment as the transmission data in the lower layer.

### (Flow of Transmitting Method)

At least one processor included in the transmitting apparatus 1 executes a transmitting method S1. A flow of the transmitting method S1 is described with reference to FIG. 2. FIG. 2 is a flowchart illustrating the flow of the transmitting method S1. The transmitting method S1 includes a reading process S11 and an encoding and transmitting process S12, as illustrated in FIG. 2.

In the reading process S11, in the application layer, the at least one processor reads out, from the first area, a plurality of data segments into which transmission data in the application layer has been divided. In the encoding and transmitting process S12, in the application layer, while generating an encoded data segment with use of the plurality of data segments, the at least one processor writes, in the second area, the encoded data segment as transmission data in the lower layer.

### (Effect of Transmitting Apparatus and Transmitting Method)

As described above, the transmitting apparatus 1 employs a configuration such that the transmitting apparatus 1 includes the foregoing reading section 11, the foregoing encoding and transmitting section 12, and the foregoing memory 100. The transmitting method S1 employs a configuration such that the transmitting method S1 includes the foregoing reading process S11 and the foregoing encoding and transmitting process S12. Therefore, the transmitting apparatus 1 and the transmitting method S1 each bring about an effect of suppressing an increase in processing cost in the case of introducing a new encoding scheme into an existing communication scheme.

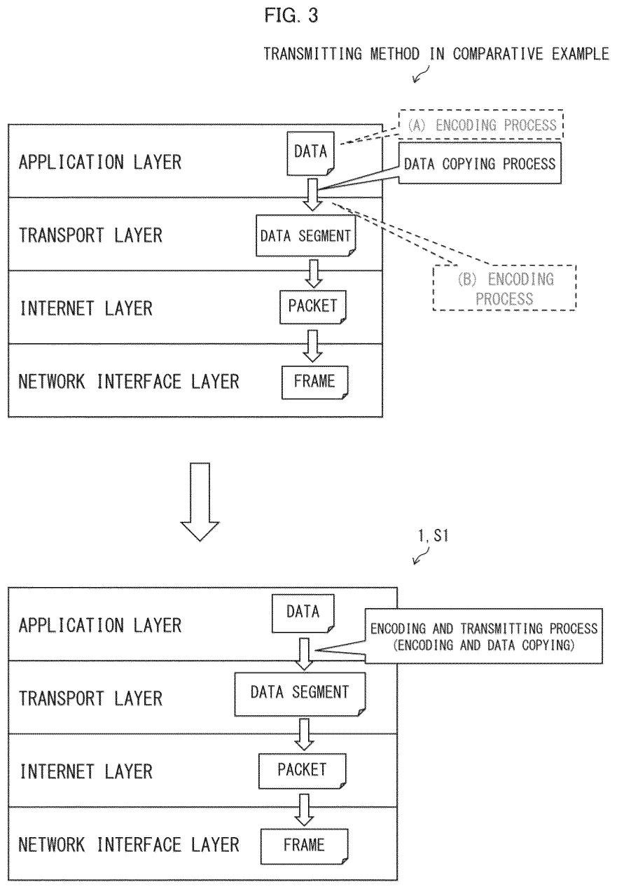

Here, the effect of each of the transmitting apparatus 1 and the transmitting method S1 is described in comparison with a comparative example with reference to FIG. 3. FIG. 3 is a drawing schematically illustrating the effect of each of the transmitting apparatus 1 and the transmitting method S1. In FIG. 3, the communication model is assumed to be a TCP/IP communication model. In this case, the “application layer” in the present specification corresponds to an application layer in the TCP/IP communication model. The “lower layer” in the present specification corresponds to each of a transport layer (such as a TCP or a UDP), an Internet layer (such as an IP), and a network interface layer (such as Ethernet (registered trademark)) in the TCP/IP communication model. Note, however, that the communication model in the present example embodiment is not limited to the TCP/IP communication model. For example, the “application layer” in the present specification corresponds to each of an application layer, a presentation layer, and a session layer in an OSI reference model. The “lower layer” in the present specification corresponds to each of a transport layer, a network layer, a data link layer, and a physical layer in the OSI reference model.

As illustrated in FIG. 3, in an existing transmitting method in the comparative example, a data copying process occurs so that transmission data in the application layer is passed to the lower layer. Note that an existing encoding process in the existing transmitting method is executed in the lower layer. Note, here, that in a case where a new encoding process is introduced, it is considered to (A) execute the new encoding process before the transmission data is passed to the lower layer or (B) execute the new encoding process after the transmission data is passed to the lower layer. However, in both cases of (A) and (B), a data copying process occurs in the new encoding process, in addition to the data copying process for passing the transmission data from the application layer to the lower layer. This halves transmission performance.

In contrast, in the transmitting apparatus 1 and the transmitting method S1, executed is the encoding and transmitting process that, in the application layer, while an encoded data segment is generated with use of a plurality of data segments read out from the first area, the encoded data segment is written in the second area as transmission data in the lower layer, as illustrated in FIG. 3. That is, the encoding and transmitting process in the transmitting apparatus 1 and the transmitting method S1 is executed also as a data copying process for passing data from the application layer to the lower layer. Therefore, it is possible to save one data copying process, and possible to suppress an increase in transmission processing cost which increase is caused by introduction of a new encoding scheme into an existing communication scheme.

### (Configuration of Receiving Apparatus)

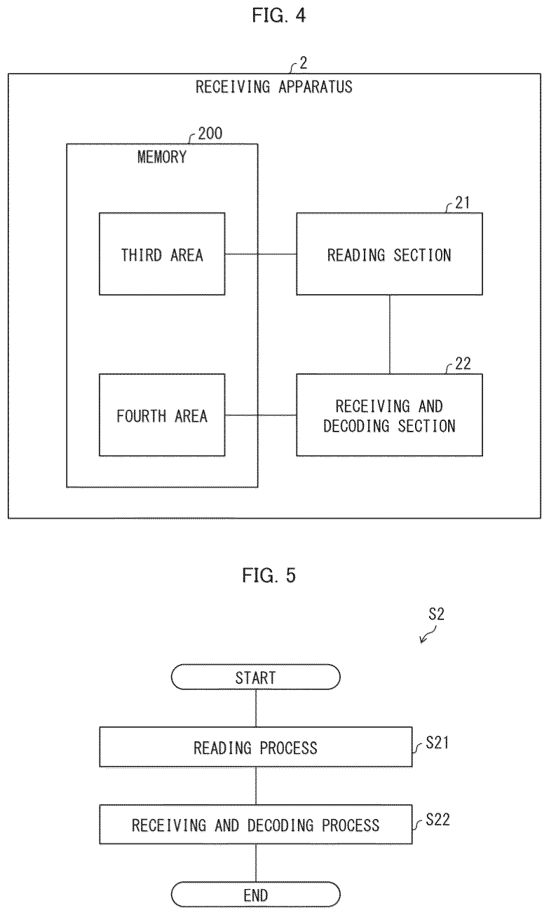

A receiving apparatus 2 is an apparatus which receives an encoded data segment(s) that has/have been transmitted by the transmitting apparatus 1. A configuration of the receiving apparatus 2 is described with reference to FIG. 4. FIG. 4 is a block diagram illustrating the configuration of the receiving apparatus 2. The receiving apparatus 2 includes a reading section 21, a receiving and decoding section 22, and a memory 200, as illustrated in FIG. 4.

The memory 200 includes a third area in which reception data in the lower layer is stored and a fourth area in which reception data in the application layer is stored. In the application layer, the reading section 21 reads out, from the third area, the encoded data segment(s) which is/are the reception data in the lower layer. In the application layer, while obtaining a plurality of data segments by decoding the encoded data segments, the receiving and decoding section 22 writes, in the fourth area, the plurality of data segments as the reception data in the application layer.

### (Flow of Receiving Method)

At least one processor included in the receiving apparatus 2 executes a receiving method S2. The receiving method S2 is a method for receiving the encoded data segment(s) transmitted by the transmitting method S1. A flow of the receiving method S2 is described with reference to FIG. 5. FIG. 5 is a flowchart illustrating the flow of the receiving method S2. The receiving method S2 includes a reading process S21 and a receiving and decoding process S22, as illustrated in FIG. 5.

In the reading process S21, in the application layer, the at least one processor reads out, from the third area, the encoded data segment(s) which is/are reception data in the lower layer. In the receiving and decoding process S22, in the application layer, while obtaining a plurality of data segments by decoding the encoded data segments, the at least one processor writes, in the fourth area, the plurality of data segments as reception data in the application layer.

### (Effect of Receiving Apparatus and Receiving Method)

As described above, the receiving apparatus 2 employs a configuration that the receiving apparatus 2 includes the foregoing reading section 21 and the foregoing receiving and decoding section 22. The receiving method S2 employs a configuration such that the receiving method S2 includes the foregoing reading process S21 and the foregoing receiving and decoding process S22. Therefore, the receiving apparatus 2 and the receiving method S2 each bring about an effect of suppressing an increase in processing cost in the case of introducing a new encoding scheme into an existing communication scheme.

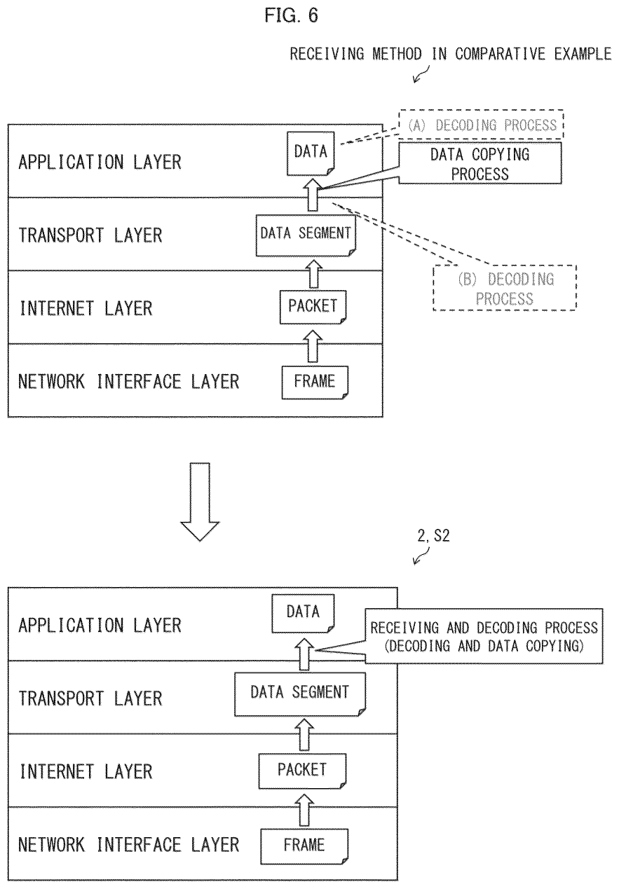

Here, the effect of each of the receiving apparatus 2 and the receiving method S2 is described in comparison with a comparative example with reference to FIG. 6. FIG. 6 is a drawing schematically illustrating the effect of each of the receiving apparatus 2 and the receiving method S2. In FIG. 6, the communication model is assumed to be a TCP/IP communication model, as in FIG. 3. However, the communication model in the present example embodiment is not limited to the TCP/IP communication model.

As illustrated in FIG. 6, in an existing receiving method in the comparative example, a data copying process occurs so that reception data in a lower layer is passed to an application layer. Note that a decoding process corresponding to an existing encoding process in the existing receiving method is executed in the lower layer. Note, here, that in a case where a new encoding process is introduced, it is considered to (A) execute a decoding process corresponding to the new encoding process after passing the reception data to the application layer or (B) execute the decoding process before passing the reception data the application layer. However, in both cases of (A) and (B), a data copying process occurs in the new decoding process, in addition to the data copying process for passing the reception data from the lower layer to the application layer. This halves reception performance.

In contrast, in the receiving apparatus 2 and the receiving method S2, executed is the receiving and decoding process that, in the application layer, while a plurality of data segments are obtained by decoding the encoded data segments read out from the third area, the plurality of data segments are written in the fourth area as reception data in the application layer, as illustrated in FIG. 6. That is, the receiving and decoding process is executed also as a data copying process for passing data from the lower layer to the application layer. Therefore, it is possible to save one data copying process, and possible to suppress an increase in reception processing cost which increase is caused by introduction of a new encoding scheme into an existing communication scheme.

### Second Example Embodiment

The following description will discuss a second example embodiment, which is an example of an embodiment of the present invention, in detail, with reference to the drawings. The same reference signs are given to constituent elements having the same functions as those of the constituent elements described in the foregoing example embodiment, and descriptions of the constituent elements are omitted as appropriate. Note that the scope of application of technical means which are employed in the present example embodiment is not limited to the present example embodiment. That is, the technical means which are employed in the present example embodiment can be employed also in the other example embodiments included in the present disclosure, within a range in which no particular technical problem occurs. Moreover, technical means indicated in the drawings referred to for describing the present example embodiment can be employed also in the other example embodiments included in the present disclosure, within a range in which no particular technical problem occurs.

### (Configuration of Communication System)

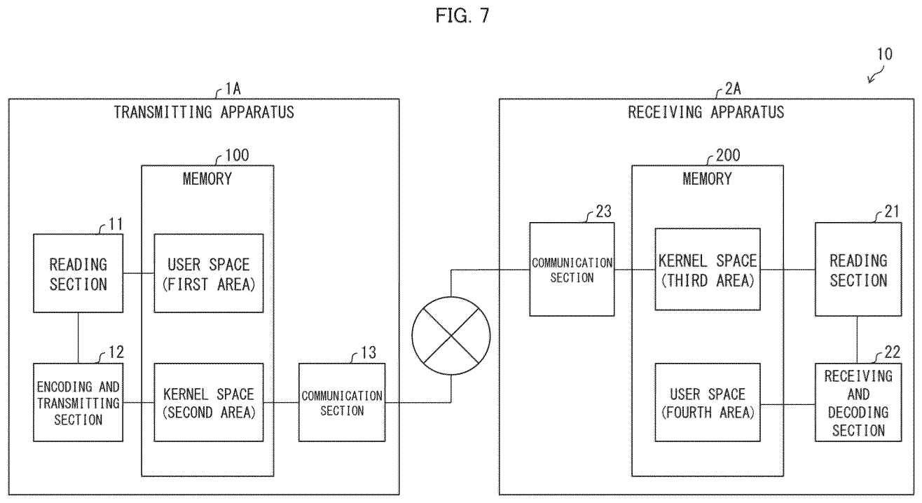

A configuration of a communication system 10 is described with reference to FIG. 7. FIG. 7 is a block diagram illustrating the configuration of the communication system 10. As illustrated in FIG. 7, the communication system 10 includes a transmitting apparatus 1A and a receiving apparatus 2A. The transmitting apparatus 1A and the receiving apparatus 2A are connected to each other via a network. The communication system 10 may be a system which transmits and receives data on the basis of, for example, a TCP/IP communication model, but a communication model is not limited to the TCP/IP communication model.

### (Configuration of Transmitting Apparatus)

As illustrated in FIG. 7, the transmitting apparatus 1A includes a memory 100, a reading section 11, an encoding and transmitting section 12, and a communication section 13. As a first area included in the memory 100, user space is applied. As a second area included in the memory 100, kernel space is applied.

The reading section 11 is configured as follows, in addition to being configured as in the first example embodiment. The reading section 11 repeats reading out a new data segment from the user space.

The encoding and transmitting section 12 is configured as follows, in addition to being configured as in the first example embodiment. The encoding and transmitting section 12 repeats writing a new encoded data segment in the second area, while generating the new encoded data segment with use of, among data segments read out by the reading section 11, (i) at least one data segment which has been already used to generate an encoded data segment and (ii) the new data segment. Note that the number of times the encoding and transmitting section 12 repeats generating a new encoded data segment is up to the number of data segments which can be stored concurrently in a cache memory in at least one processor included in the transmitting apparatus 1A.

The communication section 13 executes a process of transmitting data in a lower layer. A part or all of the communication section 13 may be realized by the at least one processor included in the transmitting apparatus 1A executing a program. Alternatively, a part or all of the communication section 13 may be realized as hardware. Examples of the hardware which can realize a part or all of the communication section 13 include a network interface controller (NIC) corresponding to a communication protocol of the lower layer. In this case, the NIC accesses the memory 100 via a direct memory access controller (DMA).

### (Flow of Transmitting Method)

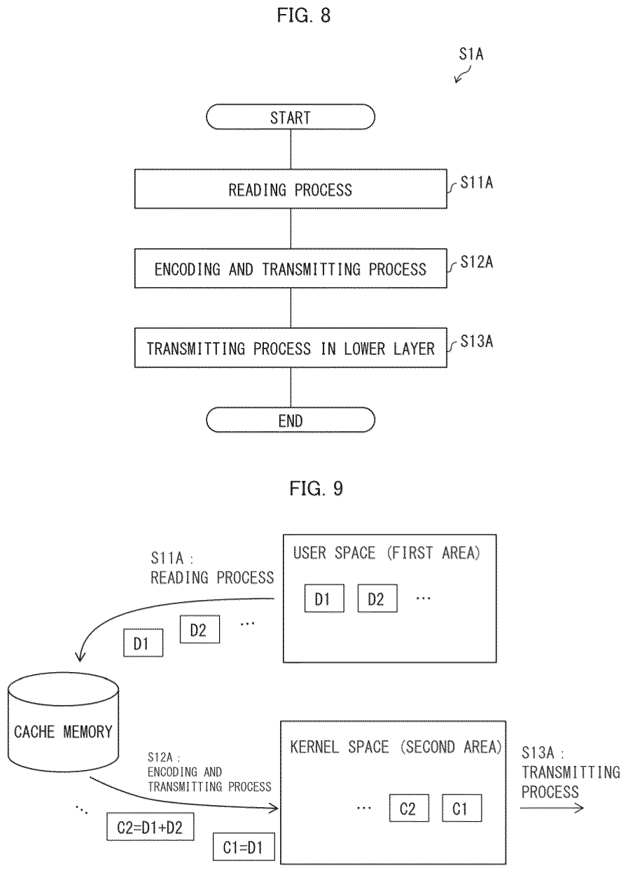

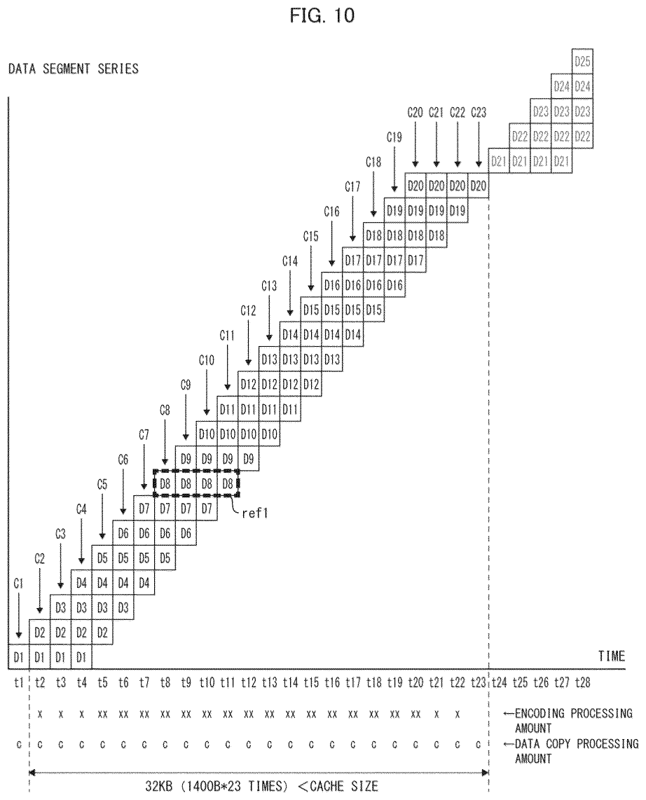

A flow of a transmitting method SIA executed by the transmitting apparatus 1A is described with reference to FIGS. 8 and 9. FIG. 8 is a flowchart illustrating the flow of the transmitting method S1A. FIG. 9 is a drawing schematically illustrating the transmitting method SIA. As illustrated in FIG. 8, the transmitting method SIA includes steps S11A, S12A, and S13A.

The step S11A is an example of a reading process. In the step S11A, in an application layer, the reading section 11 repeats reading out a new data segment from the user space. Data segments read out are stored in the cache memory embedded in the processor included in the transmitting apparatus 1A. For example, as illustrated in FIG. 9, in a case where data segments D1, D2, . . . into which transmission data in the application layer has been divided are stored in the user space, the reading section 11 sequentially reads the data segments D1, D2, . . . into the cache memory.

The step S12A is an example of an encoding and transmitting process. In the step S12A, in the application layer, the encoding and transmitting section 12 repeats writing a new encoded data segment in the kernel space, while generating the new encoded data segment with use of (i) at least one data segment which has been already used and (ii) the new data segment.

For example, as illustrated in FIG. 9, the encoding and transmitting section 12 first writes, into the kernel space, the first data segment D1 which has been read into the cache memory, as it is, as an encoded data segment C1. Further, the encoding and transmitting section 12 writes an encoded data segment C2 into the kernel space from the cache memory, while generating the encoded data segment C2 with use of (i) the data segment D1 which has been already used and (ii) a new data segment D2.

In the step S13A, in the lower layer, the communication section 13 executes a transmitting process of reading out an encoded data segment(s) written in the kernel space and transmitting the encoded data segment(s) to the outside of the transmitting apparatus 1A. In an example illustrated in FIG. 9, the encoded data segments C1, C2, . . . are sequentially transmitted to the outside.

### (Detailed Example of Encoding and Transmitting Process)

A detailed example of the encoding and transmitting process in the step S12A is described with reference to FIG. 10. FIG. 10 is a schematic view illustrating the detailed example of the encoding and transmitting process. In FIG. 10, a horizontal axis indicates elapse of time, and a vertical axis indicates a series of data segments. In this example, a time at which a data segment Di is read into the cache memory is represented by ti. A higher index i indicates that more time has elapsed. One encoded data segment is generated by encoding up to n data segments. Note that n is a natural number and represents redundancy, and n=4 in the example illustrated in FIG. 10. In FIG. 10, rectangle columns arranged vertically each indicate up to four data segments which have been encoded to one encoded data segment. Note that a process of generating an encoded data segment with use of a plurality of data segments may be, for example, a process of calculating, as the encoded data segment, an exclusive disjunction of the plurality of data segments.

For example, at a time t1, a data segment D1 is applied, as it is, as an encoded data segment C1. That is, the data segment D1 is used to generate the encoded data segment C1. At a time t2, an encoded data segment C2 is generated with use of a total of two data segments of the data segment D1 which has been used and a new data segment D2. Similarly, at a time t3, an encoded data segment C3 is generated with use of a total of three data segments of the data segments D1 and D2 which have been already used and a new data segment D3. At a time t4, an encoded data segment C4 is generated with use of a total of four data segments of the data segments D1 to D3 which have been already used and a new data segment D4.

In a case where i>n and i≤N−n+1, the encoding and transmitting process at each time is expressed by formula (1) below. Note that n is redundancy described above, and n is 4 here. N is the upper limit which defines the number of times the encoding and transmitting process is repeated. Details of N will be described later, but N is 23 here. That is, in this example, the following formula (1) is applied from a time t5 to a time t20.

$${C}_{i} = {D}_{i} + {D}_{i - 1} + ⋯ + {D}_{i - n + 1} \qquad ( 1 )$$

In formula (1), Di represents a new data segment, and Ci represents an encoded data segment generated with use of the data segment Di for the first time. Further, “+” represents an exclusive disjunction.

As indicated by formula (1), the encoded data segment Ci is obtained by encoding (i) D[i−n+1] to D[i−1] which are n−1 data segments among n data segments used in the previous generating process and (ii) the new data segment Di.

For example, at a time t8, a new encoded data segment C8 is obtained by encoding (i) D2 to D4 which are three of four data segments D1 to D4 used in the previous generating process and (ii) a new data segment D5. By, while adding 1 to i, repeating such an encoding and transmitting process of generating the encoded data segment Ci, the same data segment Di is used n times successively. For example, as indicated by a reference sign ref1 in FIG. 10, a data segment D8 is used four times successively. Thus, a cache hit of a data segment used in the process of generating an encoded data segment is likely to occur. This contributes to speeding up the process.

In a case where i>N−n+1 and i≤N, the encoded data segment Ci is generated with use of a data segment which has been already used, without use of the new data segment Di. Further, in this case, the encoded data segment Ci is generated with use of less than n data segments, and the number of data segments used is reduced by one each time i is increased by one. For example, in the example illustrated in FIG. 10, at a time t21, a new encoded data segment C21 is obtained by encoding D18 to D20 which are three of four data segments D17 to D20 used in the previous process. At a time t22, a new encoded data segment C22 is obtained by encoding D19 to D20 which are two of three data segments D18 to D20 used in the previous process. At a time t23, a new encoded data segment C23 is obtained by applying D20, as it is, which is one of two data segments D19 and D20 used in the previous process.

In this manner, the encoding and transmitting process of writing encoded data segments C1 to CN in the kernel space while generating the encoded data segments C1 to CN is repeated N times. N is determined on the basis of the number of data segments which can be stored concurrently in the cache memory. For example, N is determined such that the size of a data segment×(N−1)<a cache size. N−1 is the number of data segments which can be stored concurrently in the cache memory.

In the example illustrated in FIG. 10, it is assumed that the size of a data segment is 1400 B (byte) and the cache size is 32 K (kilobyte), and it is determined that N=23. Note that each process of generating the encoded data segments C2 to C20 among C1 to C23 is an example of the “process of generating a new encoded data segment with use of, among data segments read out by the reading section 11, (i) at least one data segment which has been already used to generate an encoded data segment and (ii) a new data segment”. Namely, the number of times the “process of generating a new encoded data segment” is repeated is 19 times corresponding to C2 to C20. That is, the number of times is up to (i.e., equal to or less than) the number of data segments (22 data segments) which can be stored concurrently in the cache memory. Note that methods for determining the size of a data segment, the cache size, and N are not limited to the example described above.

Note that the encoding and transmitting process executed after the encoding and transmitting process is repeated N times is described similarly to the above by incrementing, from 1 again in order, the index i of the data segment Di which is subsequently read out and the encoded data segment Ci which is subsequently generated. In the example illustrated in FIG. 10, the encoding and transmitting process is executed similarly to the above, by regarding, as the data segments D1, D2, D3, D4, D5 . . . , data segments D21, D22, D23, D24, D25 . . . which are subsequently read out.

By setting, to N in this manner, the upper limit of number the of times the encoding and transmitting process is repeated, a possibility that a data segment used in the encoding and transmitting process is stored in the cache become high, and speeding up of the process can be expected.

Formula (1) can be modified as follows.

$${C}_{i} = {D}_{i} + {C}_{i - 1} - {D}_{i - n} \qquad ( 2 )$$

In formula (2), “−” represents an exclusive disjunction, similarly to “+”.

For example, a new encoded data segment C5 at the time t5 is obtained by encoding with use of the encoded data segment C4 which has been generated in the previous process, the new data segment D5, and the data segment D1 which has been used four processes ago. By, while adding 1 to i, repeating such a process of generating the encoded data segment Ci, the data segment Di is used again n processes later. For example, in the example illustrated in FIG. 10, the data segment D8 used to generate the encoded data segment C8 is used again in the process of generating an encoded data segment C12. Therefore, also in this case, a cache hit of a data segment used in the encoding and transmitting process is likely to occur. This contributes to speeding up the process.

In FIG. 10, the number of characters “x” shown below each time ti indicates an encoding processing cost at each time ti in a case where formula (2) is used. For example, at the time t1, the data segment D1 only needs to be set, as it is, as the encoded data segment C1. Therefore, no encoding processing cost occurs, and a character “x” is not shown. At the time t2, since a process corresponding to one operation of calculating an exclusive disjunction of the new data segment D2 and the encoded data segment C1 which has been generated in the previous process occurs, one character of “x” is shown. The same applies to the times t3 and t4.

At the time t5, required are a total of two operations of an operation of calculating an exclusive disjunction of the new data segment D5 and the encoded data segment C4 which has been generated in the previous process and (ii) an operation of calculating an exclusive disjunction of this operation result and the data segment D1 which has been used four processes ago. Therefore, as for the time t5, two characters of “x” are shown. The same applies to times t6 to t20.

At the time t21, since a process corresponding to one operation of calculating an exclusive disjunction of (i) the encoded data segment C20 which has been generated in the previous process and (ii) the data segment D17 which has been used four processes ago occurs, one character of “x” is shown. The same applies to the time t22. At the time t23, the data segment D20 only needs to be set, as it is, as the encoded data segment C23. Therefore, no encoding processing cost occurs, and a character “x” is not shown.

In FIG. 10, the number of characters “C” shown below each time ti indicates a data copy processing cost at each time ti. At any time ti, occurs one data copying process of reading out one data segment Di from the user space and writing one encoded data segment Ci in the kernel space. Therefore, one character “C” is shown.

In this manner, the encoding and transmitting section 12 executes a data copying process associated with an encoding process, also as a data copying process of copying data from the user space to the kernel space for passing the data from the application layer to the lower layer. Therefore, it is possible to save one data copying process, and possible to reduce a decrease in transmission performance which decrease is caused by introduction of a new encoding scheme.

### (Configuration of Receiving Apparatus)

A configuration of the receiving apparatus 2A is described with reference to FIG. 7. The receiving apparatus 2A includes a memory 200, a reading section 21, a receiving and decoding section 22, and a communication section 23, as illustrated in FIG. 7. As a third area included in the memory 200, kernel space is applied. As a fourth area included in the memory 200, user space is applied.

The communication section 23 executes a process of receiving data in the lower layer. A part or all of the communication section 23 may be realized by at least one processor included in the receiving apparatus 2A executing a program. Alternatively, a part or all of the communication section 23 may be realized as hardware. Examples of the hardware are described similarly to that of the communication section 13 included in the transmitting apparatus 1A, and, therefore, a detailed description of the hardware is not repeated.

The reading section 21 is configured as follows, in addition to being configured as in the first example embodiment. The reading section 21 repeats reading out a new encoded data segment from the kernel space.

The receiving and decoding section 22 is configured as follows, in addition to being configured as in the first example embodiment. The receiving and decoding section 22 repeats writing, in the user space, a new data segment which has been decoded from the new encoded data segment with use of an encoded data segment that has been already decoded, while obtaining the new data segment.

### (Flow of Receiving Method)

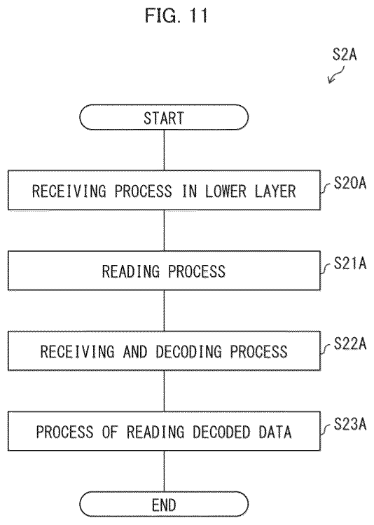

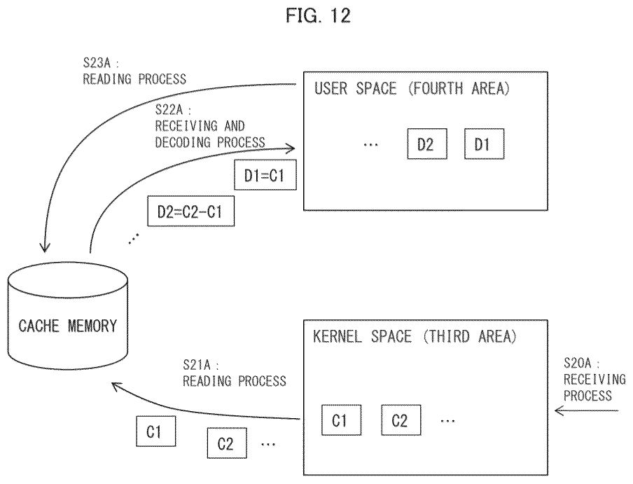

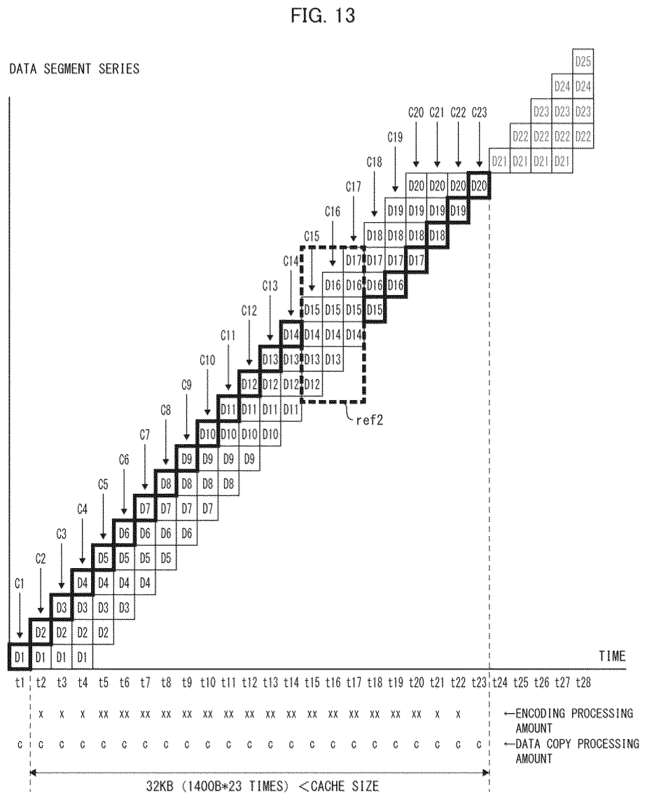

A flow of a receiving method S2A executed by the receiving apparatus 2A is described with reference to FIGS. 11 and 12. FIG. 11 is a flowchart illustrating the flow of the receiving method S2A. FIG. 12 is a drawing schematically illustrating the receiving method S2A. As illustrated in FIG. 11, the receiving method S2A includes steps S20A, S21A, S22A, and S23A.

In the step S20A, in the lower layer, the communication section 23 executes a receiving process of writing, in the kernel space, reception data which has been received from the outside of the receiving apparatus 2A. The reception data indicates the encoded data segment(s) which has/have been transmitted from the transmitting apparatus 1A by the transmitting method S1A. The communication section 23 repeats the process of receiving an encoded data segment. For example, as illustrated in FIG. 12, the encoded data segments C1, C2, . . . which are sequentially transmitted from the transmitting apparatus 1A are sequentially stored in the kernel space.

The step S21A is an example of a reading process. In the step S21A, in an application layer, the reading section 21 repeats reading, in the cache memory, a new encoded data segment.

The step S22A is an example of a receiving and decoding process. In the step S22A, in the application layer, the receiving and decoding section 22 repeats writing, in the user space, a new data segment which has been decoded from the new encoded data segment with use of an encoded data segment that has been already decoded, as reception data in the application layer, while obtaining the new data segment.

For example, as illustrated in FIG. 12, the receiving and decoding section 22 writes, in the user space, the first encoded data segment C1 read out from the kernel space, as it is, as the decoded data segment D1. The receiving and decoding section 22 writes, in the user space, the new data segment D2 which has been decoded from the new encoded data segment C2 with use of the encoded data segment C1 that has been already decoded, while obtaining the data segment D2. For example, the receiving and decoding section 22 can obtain the data segment D2 by subtracting, from the new encoded data segment C2, the encoded data segment C1 which has been already decoded (i.e., calculating an exclusive disjunction).

In the step S23A, the receiving apparatus 2A reads out the decoded data segments from the user space, and uses the decoded data segments. In an example illustrated in FIG. 12, the receiving apparatus 2A sequentially reads out the data segments D1, D2, . . . .

### (Detailed Example of Receiving and Decoding Process)

A detailed example of the receiving and decoding process in the step S22A is described with reference to FIG. 13. FIG. 13 is a schematic view illustrating a detailed example of the receiving and decoding process. In FIG. 13, information indicated by each of a vertical axis and a horizontal axis is described similarly to that in FIG. 10. Further, that redundancy n is 4 is also described similarly to that in FIG. 10. The maximum value N of the number of times of repetitions which maximum value N is used in the transmitting apparatus 1A is referred to in the receiving and decoding process.

For example, at a time t1, decoding is executed in which the encoded data segment C1 is set, as it is, as the data segment D1. The encoded data segment C2 newly received at a time t2 is one that has been obtained by encoding the data segments D1 and D2. Thus, at the time t2, by determining the difference between the encoded data segments C1 and C2, the decoded data segment D2 is obtained. The encoded data segment C3 newly received at a time t3 is one that has been obtained by encoding the data segments D1, D2, and D3. Thus, at the time t3, by determining the difference between the encoded data segments C2 and C3, the decoded data segment D3 is obtained. The encoded data segment C4 newly received at a time t4 is one that has been obtained by encoding the data segments D1 to D4. Thus, at the time t4, by determining the difference between the encoded data segments C3 and C4, the decoded data segment D4 is obtained.

In a case where i>2 and i≤N−n+1, the decoding process at each time is expressed by formula (3) below. Note that N is the maximum value of the number of times of repetitions described above, and is 23. That is, in this example, the following formula (3) is applied from a time t5 to a time t20.

$${D}_{i} = {C}_{i} - ( {C}_{i - 1} - {D}_{i - n} ) \qquad ( 3 )$$

As shown in formula (3), the data segment Di is decoded by determining the difference between (i) the encoded data segment Ci newly received and (ii) an operation result obtained by subtracting, from an encoded data segment C[i−1] which has been decoded, a data segment D[i−n] which has been already decoded.

For example, at the time t5, the data segment D5 is decoded by determining the difference between (i) the encoded data segment C5 newly received and (ii) an operation result obtained by subtracting the data segment D1 from the encoded data segment C4.

For example, it is assumed that, after data segments up to the data segment D14 are decoded by a time t14 in this manner, the encoded data segments C15 to C17 are consecutively lost, as indicated by a reference sign ref2 in FIG. 13. In this case, it is not possible to execute the decoding process thereafter with use of formula (3). In this case, the receiving and decoding section 22 receives encoded data segments up to the encoded data segment CN, and executes the decoding process from the back to the front. That is, in a case where an encoded data segment is lost, the receiving and decoding section 22 obtains the decoded data segment Di, while subtracting 1 from i in order from i=N.

For example, the encoded data segment C23 is one that has been obtained by applying the data segment D20 as it is. Thus, by receiving the encoded data segment C23, the “decoded” data segment D20 is obtained. The encoded data segment C22 is one that has been obtained by encoding the data segments D19 to D20. Thus, by determining the difference between the encoded data segments C19 and C20, the decoded data segment D19 is obtained. The encoded data segment C21 is one that has been obtained by encoding the data segments D18 to D20. Thus, by determining the difference between the encoded data segments C21 and C22, the data segment D18 is decoded. The encoded data segment C20 is one that has been obtained by encoding the data segments D17 to D20. Thus, by determining the difference between the encoded data segments C20 and C21, the data segment D17 is decoded.

In a case where i>2 and i≤N−n+1, the decoding process from the back at each time is expressed by formula (4) below. That is, in this example, it is possible to execute the decoding process from the back from the time t5 to the time t20 by applying the following formula (4).

$${D}_{i} = {C}_{i + n - 1} - ( {C}_{i + n} - {D}_{i + n} ) \qquad ( 4 )$$

As shown in formula (4), the data segment Di is decoded by determining the difference between (i) the encoded data segment C[i+n−1] and (ii) an operation result obtained by subtracting, from an encoded data segment C[i+n], a data segment D[i+n] which has been already decoded.

For example, the decoded data segment D16 is obtained by determining the difference between (i) the encoded data segment C19 and (ii) an operation result obtained by subtracting, from the encoded data segment C20, the data segment D20 which has been already obtained. The decoded data segment D15 is obtained by determining the difference between (i) the encoded data segment C18 and (ii) an operation result obtained by subtracting, from the encoded data segment C19, the data segment D19 which has been already obtained.

In this manner, even in a case where some of a plurality of encoded data segments Ci sequentially transmitted from the transmitting apparatus 1A are consecutively lost, it is possible to decode each data segment Di, provided that the number of times losses consecutively occur is less than n. This is because each data segment Di is made redundant with the redundancy n.

Moreover, also in the receiving and decoding process, the maximum value N of the number of repetitions similar to that in the transmitting apparatus 1A is referred to. Thus, a cache hit of a data segment which has been already decoded and an encoded data segment which has been decoded and which should be used in the receiving and decoding process is highly likely to occur. Therefore, it is expected that the decoding process is sped up.

In FIG. 13, the number of characters shown below each time ti indicates a decoding processing cost at each time ti in a case where formula (3) or (4) is used. The decoding processing cost is described similarly to the encoding processing cost described with reference to FIG. 10. In FIG. 13, the number of characters “C” shown below each time ti indicates a data copy processing cost at each time ti. The data copy processing cost is also described similarly to the data copy processing cost described with reference to FIG. 10.

In this manner, the receiving and decoding section 22 executes the data copying process associated with the decoding process corresponding to a newly introduced encoding process, also as a data copying process of copying data from the kernel space to the user space for passing the data from the lower layer to the application layer. Therefore, it is possible to save one data copying process, and possible to reduce a decrease in reception performance which decrease is caused by introduction of a new encoding scheme.

### Application Example 1

In each example embodiment described above, the transmitting apparatus 1, 1A and the receiving apparatus 2, 2A can be applied to a case where a new encoding scheme is introduced into free-space optical communications (hereinafter, referred to as FSO). In the FSO, attenuation and loss of a communication signal can occur due to the following factors peculiar to the FSO, in addition to the random noise (Gaussian noise) which follows a normal distribution and which is a general problem in communication. An example factor peculiar to the FSO is atmospheric turbulence which causes a beam to be randomly refracted in the atmosphere that is a communication medium. Another example factor is attenuation due to rainfall. Still another example factor is an axis shift of the beam which axis shift is caused by a housing vibrating due to a strong wind, an earthquake, or the like. Thus, in the FSO, a burst error can occur for longer time than in a general communication. Therefore, in the FSO, it is required to add a new encoding process. Under the circumstances, by applying each example embodiment of the present invention to the FSO, it is possible to, in the FSO, introduce a new encoding process while suppressing an increase in processing cost.

### Application Example 2

In each example embodiment described above, the reading section 11 and the encoding and transmitting section 12 may be included in a data transfer function, a web server function, a web browser function, or a hyper text transfer protocol 3 (HTTP3)-based function. In other words, at least one processor included in the transmitting apparatus 1, 1A may execute the reading process S11, S11A and the encoding and transmitting process S12, S12A as a process relating to the data transfer function, the web server function, the web browser function, or the HTTP3-based function.

Further, the reading section 21 and the receiving and decoding section 22 may be included in the data transfer function, the web server function, the web browser function, or the HTTP3-based function. In other words, at least one processor included in the receiving apparatus 2, 2A may execute the reading process S21, S21A and the receiving and decoding process S22, S22A as a process relating to the data transfer function, the web server function, the web browser function, or the HTTP3-based function.

In this case, the transmitting apparatus 1, 1A and receiving apparatus 2, 2A may be each an apparatus having the data transfer function, the web server function, the web browser function, or the HTTP3-based function. Note that, in the HTTP3-based function, there is a case where, in addition to the process in the application layer, the process in the lower layer is executed instead of an OS kernel. In this case, given areas of the user space are applied as the first area, the second area, the third area, and the fourth area, respectively.

### (Effect of Communication System)

As has been described, the transmitting apparatus 1A employs a configuration such that the reading section 11 repeats reading out a new data segment from the first area and the encoding and transmitting section 12 repeats writing a new encoded data segment in the second area, while generating the new encoded data segment with use of (i) a plurality of data segments which have been already used and (ii) the new data segment. Therefore, the transmitting apparatus 1A brings about, in addition to the effect brought about by the transmitting apparatus 1, an effect that, since a data segment read out is successively and repeatedly used, a cache hit is likely to occur and, therefore, it is possible to speed up the encoding and transmitting process.

Moreover, the transmitting apparatus 1A employs a configuration such that the number of times generation of the new encoded data segment is repeated is up to the number of data segments which can be stored concurrently in a cache memory in at least one processor. Therefore, the transmitting apparatus 1A brings about, in addition to the effect brought about by the transmitting apparatus 1, an effect that it is possible to further increase a possibility that a cache hit of a “data segment which has been already used”, which should be used in a case where an encoded data segment is generated, occurs and, therefore, it is possible to speed up the encoding and transmitting process.

Furthermore, the transmitting apparatus 1A employs a configuration such that the first area is user space and the second area is kernel space. Therefore, the transmitting apparatus 1A brings about, in addition to the effect brought about by the transmitting apparatus 1, an effect that, in an application which is configured to pass transmission data to an OS kernel that executes a transmitting process in a lower layer, it is possible to introduce a new encoding scheme while reducing a decrease in transmission performance.

The receiving apparatus 2A employs a configuration such that (i) in an application layer, the reading section 21 repeats reading out an encoded data segment from the third area and (ii) the receiving and decoding section 22 repeats writing, in the fourth area, a new data segment which has been decoded from a new encoded data segment with use of an encoded data segment that has been already decoded, while obtaining the new data segment. Therefore, the receiving apparatus 2A brings about, in addition to the effect brought about by the receiving apparatus 2, an effect that a cache hit of an “encoded data segment which has been already decoded”, which should be used in a case where a new encoded data segment is decoded, is likely to occur and, therefore, it is possible to speed up the receiving and decoding process.

Moreover, the receiving apparatus 2A employs a configuration such that the third area is kernel space and the fourth area is user space. Therefore, the receiving apparatus 2A brings about, in addition to the effect brought about by the receiving apparatus 2, an effect that, in an application which is configured to receive data received from an OS kernel that executes a receiving process in a lower layer, it is possible to introduce a new encoding scheme while reducing a decrease in reception performance.

### [Software Implementation Example]

Some or all of the functions of the transmitting apparatus 1, 1A and the receiving apparatus 2, 2A (hereinafter also referred to as “each apparatus”) may be implemented by hardware such as an integrated circuit (IC chip), or may be implemented by software.

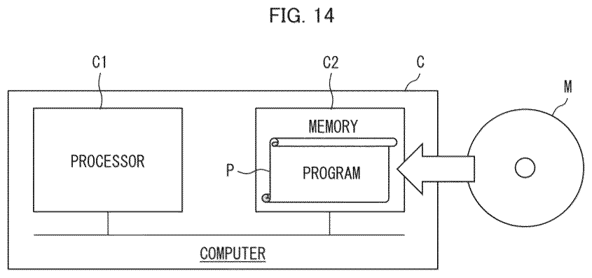

In the latter case, the each apparatus is realized by, for example, a computer that executes instructions of a program that is software realizing the functions. FIG. 14 illustrates an example of such a computer (hereinafter, referred to as “computer C”). FIG. 14 is block illustrating a diagram a hardware configuration of the computer C which functions as the each apparatus.

The computer C includes at least one processor C1 and at least one memory C2. In the memory C2, a program P for causing the computer C to operate as the each apparatus is recorded. In the computer C, the processor C1 retrieves the program P from the memory C2 and executes the program P, so that the functions of the each apparatus are implemented.

The processor C1 can be, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. The memory C2 can be, for example, a flash memory, a hard disk drive (HDD), a solid state drive (SSD), or a combination of these.

Note that the computer C may further include a random access memory (RAM) in which the program P is loaded in a case where the program P is executed and in which various kinds of data are temporarily stored. The computer C may further include a communication interface via which the computer C transmits and receives data to and from another apparatus. The computer C may further include an input/output interface via which the computer C is connected to an input/output apparatus such as a keyboard, a mouse, a display, and a printer.

The program P can be stored in a non-transitory tangible recording medium M which is readable by the computer C. The recording medium M can be, for example, a tape, a disk, a card, a semiconductor memory, a programmable logic circuit, or the like. The computer C can obtain the program P via the recording medium M. The program P can be transmitted via a transmission medium. The transmission medium can be, for example, a communications network, a broadcast wave, or the like. The computer C can obtain the program P also via such a transmission medium.

### [Additional Remark A]

The present disclosure includes techniques described in supplementary notes below. Note, however, that the present invention is not limited to the techniques described in the supplementary notes below, but may be altered in various ways by a skilled person within the scope of the claims.

### (Supplementary Note A1)

A transmitting method which is executed by a transmitting apparatus including at least one processor and a memory,
the memory including a first area in which transmission data in an application layer of a communication model is stored and a second area in which transmission data in a lower layer that is below the application layer is stored,
the transmitting method including:
a reading process in which, in the application layer, the at least one processor reads out, from the first area, a plurality of data segments into which the transmission data in the application layer has been divided; and
an encoding and transmitting process in which, in the application layer, while generating an encoded data segment with use of the plurality of data segments, the at least one processor writes, in the second area, the encoded data segment as the transmission data in the lower layer.

### (Supplementary Note A2)

The transmitting method as described in Supplementary note A1, wherein
in the reading process, the at least one processor repeats reading out a new data segment from the first area, and
in the encoding and transmitting process, the at least one processor repeats writing a new encoded data segment in the second area, while generating the new encoded data segment with use of, among data segments read out by the at least one processor, (i) at least one data segment which has been already used to generate the encoded data segment and (ii) the new data segment.

### (Supplementary Note A3)

The transmitting method as described in Supplementary note A2, wherein, in the encoding and transmitting process, the number of times generation of the new encoded data segment is repeated is up to the number of data segments which can be stored concurrently in a cache memory in the at least one processor.

### (Supplementary Note A4)

The transmitting method as described in Supplementary note A1 or A2, wherein
the first area is user space, and
the second area is kernel space.

### (Supplementary Note A5)

The transmitting method as described in Supplementary note A1 or A2, wherein the at least one processor executes each of the reading process and the encoding and transmitting process as a process relating to a data transfer function, a web server function, a web browser function, or a hyper text transfer protocol 3 (HTTP3)-based function.

### (Supplementary Note A6)

A receiving method in which a receiving apparatus including at least one processor and a memory receives the encoded data segment that has been transmitted by the transmitting method described in Supplementary note A1,
the memory including a third area in which reception data in the lower layer is stored and a fourth area in which reception data in the application layer is stored,
the receiving method including:
a reading process in which, in the application layer, the at least one processor reads out, from the third area, the encoded data segment which is the reception data in the lower layer; and
a receiving and decoding process in which, in the application layer, while obtaining a data segment which has been decoded with use of the encoded data segment, the at least one processor writes, in the fourth area, the data segment which has been decoded, as the reception data in the application layer.

### (Supplementary Note A7)

The receiving method as described in Supplementary note A6, wherein
in the reading process, the at least one processor repeats reading out a new encoded data segment from the third area,
in the receiving and decoding process, the at least one processor repeats writing, in the fourth area, a new data segment which has been decoded from the new encoded data segment with use of the encoded data segment that has been already decoded, while obtaining the new data segment.

### (Supplementary Note A8)

The receiving method as described in Supplementary note A6 or A7, wherein the third area is kernel space, and the fourth area is user space.

### (Supplementary Note A9)

The receiving method as described in Supplementary note A6 or A7, wherein the at least one processor executes each of the reading process and the receiving and decoding process as a process relating to a data transfer function, a web server function, a web browser function, or a hyper text transfer protocol 3 (HTTP3)-based function.

### [Additional Remark B]

The present disclosure includes techniques described in supplementary notes below. Note, however, that the present invention is not limited to the techniques described in the supplementary notes below, but may be altered in various ways by a skilled person within the scope of the claims.

### (Supplementary Note B1)

A transmitting apparatus including a memory,
the memory including a first area in which transmission data in an application layer of a communication model is stored and a second area in which transmission data in a lower layer that is below the application layer is stored,
the transmitting apparatus including:
a reading means for, in the application layer, reading out, from the first area, a plurality of data segments into which the transmission data in the application layer has been divided; and
an encoding and transmitting means for, in the application layer, while generating an encoded data segment with use of the plurality of data segments, writing, in the second area, the encoded data segment as the transmission data in the lower layer.

### (Supplementary Note B2)

The transmitting apparatus as described in Supplementary note B1, wherein
the reading means repeats reading out a new data segment from the first area, and
the encoding and transmitting means repeats writing a new encoded data segment in the second area, while generating the new encoded data segment with use of, among data segments read out by the reading means, (i) at least one data segment which has been already used to generate the encoded data segment and (ii) the new data segment.

### (Supplementary Note B3)

The transmitting apparatus as described in Supplementary note B2, wherein the number of times the encoding and transmitting means repeats generating the new encoded data segment is up to the number of data segments which can be stored concurrently in a cache memory in at least one processor included in the transmitting apparatus.

### (Supplementary Note B4)

The transmitting apparatus as described in Supplementary note B1 or B2, wherein the first area is user space, and the second area is kernel space.

### (Supplementary Note B5)

The transmitting apparatus as described in Supplementary note B1 or B2, wherein each of the reading means and the encoding and transmitting means is included in a means for executing a data transfer function, a web server function, a web browser function, or a hyper text transfer protocol 3 (HTTP3)-based function.

### (Supplementary Note B6)

A receiving apparatus which receives the encoded data segment that has been transmitted by the transmitting apparatus described in Supplementary note B1,
the receiving apparatus including a memory,
the memory including a third area in which reception data in the lower layer is stored and a fourth area in which reception data in the application layer is stored,
the receiving apparatus including:
a reading means for, in the application layer, reading out, from the third area, the encoded data segment which is the reception data in the lower layer; and
a receiving and decoding means for, in the application layer, while obtaining a data segment which has been decoded with use of the encoded data segment, writing, in the fourth area, the data segment which has been decoded, as the reception data in the application layer.

### (Supplementary Note B7)

The receiving apparatus as described in Supplementary note B6, wherein
the reading means repeats reading out a new encoded data segment from the third area, and
the receiving and decoding means repeats writing, in the fourth area, a new data segment which has been decoded from the new encoded data segment with use of the encoded data segment that has been already decoded, while obtaining the new data segment.

### (Supplementary Note B8)

The receiving apparatus as described in Supplementary note B6 or B7, wherein
the third area is kernel space, and
the fourth area is user space.

### (Supplementary Note B9)

The receiving apparatus as described in Supplementary note B6 or B7, wherein each of the reading means and the receiving and decoding means is included in a means for executing a data transfer function, a web server function, a web browser function, or a hyper text transfer protocol 3 (HTTP3)-based function.

### [Additional Remark C]

The present disclosure includes techniques described in supplementary notes below. Note, however, that the present invention is not limited to the techniques described in the supplementary notes below, but may be altered in various ways by a skilled person within the scope of the claims.

### (Supplementary Note C1)

A transmission program for causing a computer to execute a reading process and an encoding and transmitting process,
the computer including a memory that includes a first area in which transmission data in an application layer of a communication model is stored and a second area in which transmission data in a lower layer that is below the application layer is stored,
the reading process being a process of, in the application layer, reading out, from the first area, a plurality of data segments into which the transmission data in the application layer has been divided; and
the encoding and transmitting process being a process of, in the application layer, while generating an encoded data segment with use of the plurality of data segments, writing, in the second area, the encoded data segment as the transmission data in the lower layer.
   (Supplementary note C2)

The transmission program as described in Supplementary note C1, wherein
the transmission program causes the computer to, in the reading process, repeat reading out a new data segment from the first area, and
the transmission program causes the computer to, in the encoding process, repeat writing a new encoded data segment in the second area, while generating the new encoded data segment with use of, among data segments read out in the reading process, (i) at least one data segment which has been already used to generate the encoded data segment and (ii) the new data segment.

### (Supplementary Note C3)

The transmission program as described in Supplementary note C2, wherein, in the encoding and transmitting process, the number of times the computer is caused to repeat generating the new encoded data segment is up to the number of data segments which can be stored concurrently in a cache memory in at least one processor included in the computer.

### (Supplementary Note C4)

The transmission program as described in Supplementary note C1 or C2, wherein
the first area is user space, and
the second area is kernel space.

### (Supplementary Note C5)

The transmission program as described in Supplementary note C1 or C2, wherein the transmission program causes the computer to execute each of the reading process and the encoding and transmitting process as a process relating to a data transfer function, a web server function, a web browser function, or a hyper text transfer protocol 3 (HTTP3)-based function.

### (Supplementary Note C6)

A reception program for receiving the encoded data segment that has been transmitted by execution of the transmission program described in Supplementary note C1,
the reception program causing a computer to execute a reading process and a receiving and decoding process,
the computer including a memory that includes a third area in which reception data in the lower layer is stored and a fourth area in which reception data in the application layer is stored,
the reading process being a process of, in the application layer, reading out, from the third area, the encoded data segment which is the reception data in the lower layer; and
the receiving and decoding process being a process of, in the application layer, while obtaining a data segment which has been decoded with use of the encoded data segment, writing, in the fourth area, the data segment as the reception data in the application layer.

### (Supplementary Note C7)

The reception program as described in Supplementary note C6, wherein
the reception program causes the computer to, in the reading process, repeat reading out a new encoded data segment from the third area, and
the reception program causes the computer to, in the receiving and decoding process, repeat writing, in the fourth area, a new data segment which has been decoded from the new encoded data segment with use of the encoded data segment that has been already decoded, while obtaining the new data segment.

### (Supplementary Note C8)

The reception program as described in Supplementary note C6 or C7, wherein
the third area is kernel space, and
the fourth area is user space.

### (Supplementary Note C9)

The reception program as described in Supplementary note C6 or C7, wherein the reception program causes the computer to execute each of the reading process and the receiving and decoding process as a process relating to a data transfer function, a web server function, a web browser function, or a hyper text transfer protocol 3 (HTTP3)-based function.

### [Additional Remark D]

The present disclosure includes techniques described in supplementary notes below. Note, however, that the present invention is not limited to the techniques described in the supplementary notes below, but may be altered in various ways by a skilled person within the scope of the claims.

### (Supplementary Note D1)

A transmitting apparatus including at least one processor and a memory,
the memory including a first area in which transmission data in an application layer of a communication model is stored and a second area in which transmission data in a lower layer that is below the application layer is stored,
the at least one processor executing:
   a reading process of, in the application layer, reading out, from the first area, a plurality of data segments into which the transmission data in the application layer has been divided; and
   an encoding and transmitting process of, in the application layer, while generating an encoded data segment with use of the plurality of data segments, writing, in the second area, the encoded data segment as the transmission data in the lower layer.

### (Supplementary Note D2)

The transmitting apparatus as described in Supplementary note D1, wherein
in the reading process, the at least one processor repeats reading out a new data segment from the first area, and
in the encoding and transmitting process, the at least one processor repeats writing a new encoded data segment in the second area, while generating the new encoded data segment with use of, among data segments read out by the at least one processor, (i) at least one data segment which has been already used to generate the encoded data segment and (ii) the new data segment.

### (Supplementary Note D3)

The transmitting apparatus as described in Supplementary note D2, wherein, in the encoding and transmitting process, the number of times generation of the new encoded data segment is repeated is up to the number of data segments which can be stored concurrently in a cache memory in the at least one processor.

### (Supplementary Note D4)

The transmitting apparatus as described in Supplementary note D1 or D2, wherein
the first area is user space, and
the second area is kernel space.

### (Supplementary Note D5)

The transmitting apparatus as described in Supplementary note D1 or D2, wherein the at least one processor executes each of the reading process and the encoding and transmitting process as a process relating to a data transfer function, a web server function, a web browser function, or a hyper text transfer protocol 3 (HTTP3)-based function.

### (Supplementary Note D6)

A receiving apparatus which receives the encoded data segment that has been transmitted by the transmitting apparatus described in Supplementary note D1,
the receiving apparatus including at least one processor and a memory,
the memory including a third area in which reception data in the lower layer is stored and a fourth area in which reception data in the application layer is stored,
the at least one processor executing:
   a reading process of, in the application layer, reading out, from the third area, the encoded data segment which is the reception data in the lower layer; and
   a receiving and decoding process of, in the application layer, while obtaining a data segment which has been decoded with use of the encoded data segment, writing, in the fourth area, the data segment as the reception data in the application layer.

### (Supplementary Note D7)

The receiving apparatus as described in Supplementary note D6, wherein
in the reading process, the at least one processor repeats reading out a new encoded data segment from the third area, and
in the receiving and decoding process, the at least one processor repeats writing, in the fourth area, a new data segment which has been decoded from the new encoded data segment with use of the encoded data segment that has been already decoded, while obtaining the new data segment.

### (Supplementary Note D8)

The receiving apparatus as described in Supplementary note D6 or D7, wherein
the third area is kernel space, and
the fourth area is user space.

### (Supplementary Note D9)

The receiving apparatus as described in Supplementary note D6 or D7, wherein the at least one processor executes each of the reading process and the receiving and decoding process as a process relating to a data transfer function, a web server function, a web browser function, or a hyper text transfer protocol 3 (HTTP3)-based function.

### [Additional Remark E]

The present disclosure includes techniques described in supplementary notes below. Note, however, that the present invention is not limited to the techniques described in the supplementary notes below, but may be altered in various ways by a skilled person within the scope of the claims.

### (Supplementary Note E1)

A non-transitory medium in which a transmission program for causing a computer to execute a reading process and an encoding and transmitting process is recorded,
the computer including a memory that includes a first area in which transmission data in an application layer of a communication model is stored and a second area in which transmission data in a lower layer that is below the application layer is stored,
the reading process being a process of, in the application layer, reading out, from the first area, a plurality of data segments into which the transmission data in the application layer has been divided; and
the encoding and transmitting process being a process of, in the application layer, while generating an encoded data segment with use of the plurality of data segments, writing, in the second area, the encoded data segment as the transmission data in the lower layer.

### (Supplementary Note E2)

A non-transitory recording medium in which a reception program for receiving the encoded data segment that has been transmitted execution of the transmission program recorded in the recording medium described in Supplementary note E1 is recorded,
the reception program causing a computer to execute a reading process and a receiving and decoding process,
the computer including a memory that includes a third area in which reception data in the lower layer is stored and a fourth area in which reception data in the application layer is stored,
the reading process being a process of, in the application layer, reading out, from the third area, the encoded data segment which is the reception data in the lower layer; and
the receiving and decoding process being a process of, in the application layer, while obtaining a data segment which has been decoded with use of the encoded data segment, writing, in the fourth area, the data segment as the reception data in the application layer.

### REFERENCE SIGNS LIST

1, 1A Transmitting apparatus
2, 2A Receiving apparatus
10 Communication system
11, 21 Reading section
12 Encoding and transmitting section
13, 23 Communication section
22 Receiving and decoding section
C1 Processor
100, 200, C2 Memory

1. A transmitting method which is executed by a transmitting apparatus including at least one processor and a memory,
the memory including a first area in which transmission data in an application layer of a communication model is stored and a second area in which transmission data in a lower layer that is below the application layer is stored,
the transmitting method comprising:
a reading process in which, in the application layer, the at least one processor reads out, from the first area, a plurality of data segments into which the transmission data in the application layer has been divided; and
an encoding and transmitting process in which, in the application layer, while generating an encoded data segment with use of the plurality of data segments, the at least one processor writes, in the second area, the encoded data segment as the transmission data in the lower layer.

2. The transmitting method as set forth in claim 1, wherein
in the reading process, the at least one processor repeats reading out a new data segment from the first area, and
in the encoding and transmitting process, the at least one processor repeats writing a new encoded data segment in the second area, while generating the new encoded data segment with use of, among data segments read out by the at least one processor, (i) at least one data segment which has been already used to generate the encoded data segment and (ii) the new data segment.

3. The transmitting method as set forth in claim 2, wherein, in the encoding and transmitting process, the number of times generation of the new encoded data segment is repeated is up to the number of data segments which can be stored concurrently in a cache memory in the at least one processor.

4. The transmitting method as set forth in claim 1, wherein
the first area is user space, and
the second area is kernel space.

5. The transmitting method as set forth in claim 1, wherein the at least one processor executes each of the reading process and the encoding and transmitting process as a process relating to a data transfer function, a web server function, a web browser function, or a hyper text transfer protocol 3 (HTTP3)-based function.

6. A receiving method in which a receiving apparatus including at least one processor and a memory receives the encoded data segment that has been transmitted by the transmitting method recited in claim 1,
the memory including a third area in which reception data in the lower layer is stored and a fourth area in which reception data in the application layer is stored,
the receiving method comprising:
a reading process in which, in the application layer, the at least one processor reads out, from the third area, the encoded data segment which is the reception data in the lower layer; and
a receiving and decoding process in which, in the application layer, while obtaining a data segment which has been decoded with use of the encoded data segment, the at least one processor writes, in the fourth area, the data segment which has been decoded, as the reception data in the application layer.

7. A transmitting apparatus comprising
at least one processor and
a memory,
the memory including a first area in which transmission data in an application layer of a communication model is stored and a second area in which transmission data in a lower layer that is below the application layer is stored,
the at least one processor executing:
a reading process of, in the application layer, reading out, from the first area, a plurality of data segments into which the transmission data in the application layer has been divided; and
an encoding and transmitting process of, in the application layer, while generating an encoded data segment with use of the plurality of data segments, writing, in the second area, the encoded data segment as the transmission data in the lower layer.

8. A receiving apparatus which receives the encoded data segment that has been transmitted by the transmitting apparatus recited in claim 7,
the receiving apparatus comprising
at least one processor and
a memory,
the memory including a third area in which reception data in the lower layer is stored and a fourth area in which reception data in the application layer is stored,
the at least one processor executing:
a reading process of, in the application layer, reading out, from the third area, the encoded data segment which is the reception data in the lower layer; and
a receiving and decoding process of, in the application layer, while obtaining a data segment which has been decoded with use of the encoded data segment, writing, in the fourth area, the data segment which has been decoded, as the reception data in the application layer.

9. A non-transitory recording medium in which a transmission program for causing at least one processor to execute the transmitting method recited in claim 1 is recorded,
the transmission program causing the at least one processor to execute the reading process and the encoding and transmitting process.

10. A non-transitory recording medium in which a reception program for causing at least one processor to execute the receiving method recited in claim 6 is recorded,
the reception program causing the at least one processor to execute the reading process and the receiving and decoding process.
